(19) United States
(12) Patent Application Publication
(10) Pub. No.: US 2022/0381975 A1
(43) Pub. Date: Dec. 1, 2022

(54) Mitigation Of Nonlinear Effects In Photonic Integrated Circuits

(71) Applicant: Google LLC, Mountain View, CA (US)

(72) Inventors: Lieven Verslegers, Redwood City, CA (US); Ryohei Urata, San Carlos, CA (US); Mohammad Sotoodeh, Livermore, CA (US); Liming Wang, San Jose, CA (US)

(21) Appl. No.: 17/330,512

(22) Filed: May 26, 2021

(51) Int. Cl. G02B 6/124; G02B 6/34; H04B 10/40

(52) U.S. Cl. CPC G02B 6/124; G02B 6/34; H04B 10/40; G02B 2006/12097

(57) ABSTRACT

A photonic integrated circuit (PIC) includes one or more couplers to interface a light source with the PIC, a splitter directly coupled to the one or more couplers at a coupling point of the PIC, a modulator to receive light from the couplers, and a connecting waveguide to connect the splitter to the modulator. The waveguide may be a rib waveguide. The PIC may be integrated with devices such as a CWDM or a PSM device, and may provide improved performance and lower attention for high optical power applications.

### BACKGROUND

Silicon photonics technology enables low-cost, low-power, high-speed optical solutions for data communications and telecommunications by scaling transceiver channels and data rates through photonic integration and electronic co-packaging. A photonic integrated circuit (“PIC”) includes multiple optical components or functions integrated with one another, often on a silicon substrate.

Optical losses accumulating along the optical signal path of a PIC can result in poor data transmission. All PIC components and their optical packaging can contribute to these losses. In order to counter these losses and preserve data transmission with low error rates, high-power continuous wave (CW) lasers are typically used as the light source for the PIC.

However, for a PIC having high index contrast and narrow waveguide dimensions, the use of high-power lasers can result in nonlinear effects such as absorption and local heating. These non-linear effects can be due to two-photon absorption, an edge effect of the waveguide, or combination thereof. These issues can add up to losses of several dB for optical powers at or approaching 16 dBm for optical signal wavelengths. These issues are not typically detected during PIC development because the lasers used during development apply a relatively low level of optical power and the losses due to the non-linear effects are not detectable until a relatively high level of optical power is applied.

### BRIEF SUMMARY

The present disclosure describes PIC designs that mitigate the nonlinear effects of high optical power by reducing the optical power density within the PIC waveguide. One example design feature involves directly coupling a splitter to a coupling point of the PIC. Another example design feature involves coupling the connecting waveguide of the PIC to the modulator using rib waveguides. These features can be applied individually or in combination in order to decrease power density of the input optical signal.

One aspect of the present disclosure is directed to a photonic integrated circuit (PIC) including at least one PIC subcircuit including one or more couplers configured to receive light from a light source, a splitter directly coupled to the one or more couplers, a modulator, and a connecting waveguide configured to connect the splitter to the modulator.

In some examples, the one or more couplers may be a pair of couplers, and the splitter may be a 2×2 splitter. The pair of couplers may be a pair of grating couplers. Additionally or alternatively, the splitter may be a 2×2 multimode interference (MMI) splitter.

In some examples, the connecting waveguide may include a plurality of waveguide arms, each arm coupled to a respective output of the splitter, the waveguide arms having equal length. The plurality of waveguide arms may be a pair of rib waveguides or a pair of strip waveguides.

In some examples, the connecting waveguide may have a width of about 400-600 nm and a height of about 200-220 nm.

In some examples, the connecting waveguide may be formed from either silicon or silicon nitride.

In some examples, the modulator may be a Mach-Zehnder modulator (MZM) configured to operate in a carrier-depletion mode. The at least one PIC subcircuit may be configured to transmit optical signals using an advanced modulation format.

In some examples, for an optical signal having a wavelength between 1310-1320 nm and received at a power level between 16-18 dBm, an attenuation of the optical signal at the at least one PIC subcircuit may be between about −0.25 dB and about −1.25 dB.

Another aspect of the present disclosure is directed to a photonic integrated circuit (PIC) including at least one PIC subcircuit including one or more couplers configured to receive an optical signal having an optical power intensity at or above 16 dBm, a rib waveguide configured to receive the optical signal from the one or more couplers and to lower the optical power intensity of the optical signal to below 16 dBm, and a modulator configured to receive the optical signal from the rib waveguide at the optical power intensity below 16 dBm and to modulate the received optical signal.

In some examples, the rib waveguide may be formed from either silicon or silicon nitride, and the modulator may include a doped portion formed from silicon.

In some examples, the modulator may be a Mach-Zehnder modulator (MZM) configured to operate in a carrier-depletion mode.

In some examples, the rib waveguide may be configured to have a lower optical confinement than a strip waveguide of comparable width.

In some examples, the PIC may include a plurality of PIC subcircuits, each including a respective connecting waveguide, a respective splitter coupled to the respective connecting waveguide of the same PIC subcircuit, and a respective modulator coupled to the respective splitter of the same PIC subcircuit. The apparatus may further include a coarse-wavelength division multiplexer (CWDM) coupled to the respective modulators of the plurality of PIC subcircuits.

In some examples, the PIC may further include an edge coupler configured to interface the CWDM with an optical fiber.

A further aspect of the present disclosure is directed to an apparatus comprising a parallel single mode (PSM) transceiver including the PIC of any one of the embodiments described herein.

Yet another aspect of the present disclosure is directed to a system including the apparatus of any one of embodiments described herein, and the light source. The light source may be a high-power continuous wave (CW) laser.

### BRIEF DESCRIPTION OF THE DRAWINGS

FIG. 1 is a schematic diagram of an example device in accordance with an aspect of the present disclosure.

FIG. 2 is a schematic diagram of an example PIC in accordance with an aspect of the present disclosure.

FIG. 3 is a diagram of an optical mode profile of the example PIC of FIG. 2.

FIG. 4 is a diagram of output power compression for the example PIC of FIG. 2.

### DETAILED DESCRIPTION

### Overview

The present disclosure provides for PIC designs that mitigate the nonlinear effects of high optical power by reducing the optical power density within the PIC waveguide, reducing mode overlap at the waveguide edges, or both. Nonlinear absorption is observed to occur mostly near the input coupling point of the PIC, where the optical power is highest. Therefore, by reducing the optical power density at the coupling point, a reduction in nonlinear effects—and by extension, a reduction in attenuation due to the nonlinear effects—can be achieved.

One example design feature involves the positioning of an optical splitter included in the PIC. Directly coupling the splitter to the coupling point drops the optical power of the splitter, typically by a factor of 2^{N}, where N is the number of stages in the splitter. This has the effect of reducing optical power density at and near the coupling point, which in turn avoids the onset of nonlinear effects for high-power optical signals and decreases attenuation along the optical path.

Another example design feature involves the type of waveguide used to connect the coupler to the modulator. Rib waveguides have the effect of delaying the onset of nonlinearity for an optical signal of a given magnitude of power by several dB. This is because rib waveguides have a relatively low optical confinement and reduced edge effects due to less overlap between optical mode and edges compared to other waveguides such as single mode strip waveguides. Thus, by using rib waveguides, an optical power density input into the modulator can be further reduced.

The above example design features can be applied individually or in combination in order to decrease power density of the input optical signal.

A PIC device including the design features described herein can be coupled to a light source such as a laser. The laser may be mounted on top of the PIC device, or coupled through a fiber or fiber array. The PIC device may also be a coarse wavelength division multiplexer (CWDM) PIC including a plurality of modulators, whereby each modulator may be adapted for a respective wavelength. On a CWDM PIC, each wavelength channel typically has its own light source. Each light source is coupled into the PIC and connected to a modulator. The modulated signals are combined with a multiplexer, then coupled to an optical fiber using an edge coupler.

This PIC design approaches described herein enable optical signals to be transmitted at higher optical power levels while maintaining performance several dB better than in standard silicon-on-insulator (SOI) platforms. The higher optical power enables higher data transmission rates, such as those required for advanced modulation formats such as PAM4, and provides for better transmitter performance. Furthermore, these improvements allow for requirements in other components of the SOI platform, such as laser power requirements, coupling optics requirements, and receiver sensitivity requirements to be relaxed. With particular attention to receiver sensitivity requirements, the improved transmitter performance may avoid the need for amplifiers to be added. Lastly, the above advantages can all be achieved while maintaining an integrated receiver, as opposed to addressing the known challenges in a discrete, component-by-component fashion. Altogether, these improvements increase production yield of the PIC while also reducing manufacturing costs.

### Example Systems

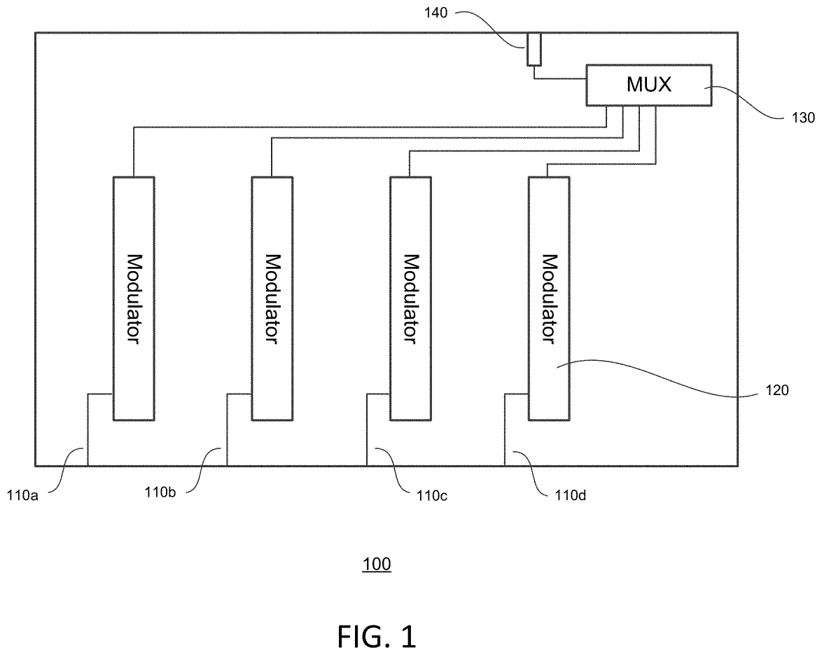

FIG. 1 is a circuit diagram of a photonic integrated circuit (PIC) device 100 including a coarse wavelength division multiplexer (CWDM) integrated with multiple PIC subcircuits. The circuit shown in the circuit diagram may be formed on a platform for silicon photonics technologies, such as a silicon-on-insulator (SOI) wafer. In the SOI wafer, optical signals may be guided through waveguides formed within a silicon (Si) layer and insulated using a silicon dioxide (SiO₂) cladding. In some instances, the cladding may be comprised of an oxide other than SiO₂.

The example circuit diagram of FIG. 1 features four PIC subcircuits 110a-110d. In other arrangements, more or fewer PIC subcircuits may be included. Each PIC subcircuit 110a-110d may be coupled to a light source such as a laser, which may be mounted on top of the PIC device, or coupled to the PIC device through a fiber or fiber array. Each PIC subcircuit may have its own respective light source.

FIG. 1 also shows the PIC device 100 as including a plurality of modulators 120, whereby each modulator is included in a respective PIC subcircuit. Each modulator 120 may be adapted to modulate optical signals at a different respective optical wavelength, such as any one or combination of 1310 nm, 1315 nm, or 1320 nm or other typical optical operating wavelengths. FIG. 1 further shows an output of each modulator 120 being connected to a multiplexer 130. The multiplexer 130 may control a connection between the modulators 120 and an output of the device 100, whereby the modulated signals may be combined and outputted by the multiplexer 130. The multiplexer 130 is coupled to an edge coupler 140 positioned at an edge of the device 100 in order to connect the device 100 to an optical fiber.

The width of the overall area of the PIC device shown in FIG. 1 may vary depending on the number of PIC subcircuits included, whereby a narrower width may be yielded by including fewer PIC subcircuits and a greater width may be required if more PIC subcircuits are included. The length of the circuit may account for the length of the modulators 120, as well as any space required for positioning the multiplexer 130 on the circuit. Typically, the length and width are on the order of millimeters. A thickness of the circuit may depend on the circuit platform. In the case of an SOI platform, thickness of the silicon layer is typically between 150-300 nm, and most commonly 220 nm, although other thicknesses of the silicon layer may be possible.

In the SOI platform, the Si layer and SiO₂ cladding may form a high index contrast, allowing for good optical confinement. Additionally, the waveguide may be formed with relatively narrow dimensions, such as a width of about 400-600 nm and a height of about 200-220 nm, thereby allowing for narrow confinement of the optical signal. The combination of the high index contrast and narrow dimensions may result in high optical power density for the transmitted optical signal, meaning that the device 100 may be configured to receive a high level of optical power.

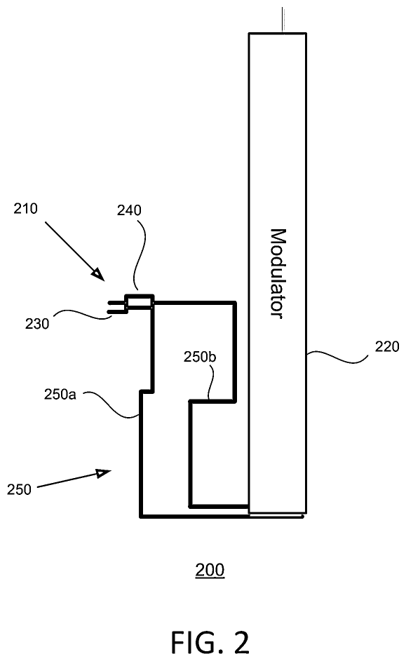

In order to avoid nonlinear effects from the high power applied, such as signal attenuation due to effects from nonlinear absorption and local heating, the PIC subcircuits included in the circuit may be specially designed to reduce optical power density within each PIC subcircuit, particularly at a respective coupling point of each PIC subcircuit. FIG. 2 is a circuit diagram on an example PIC subcircuit 200 that may be included in the device of FIG. 1 or in other devices that provide a high level of optical power.

In FIG. 2, the example PIC subcircuit 200 includes a coupling point 210 from which the optical signal is received and transmitted to a modulator 220. The modulator 220 may be a Mach-Zehnder Modulator (MZM), whereby a portion of the waveguide formed in the silicon layer is doped in order to enable high speed modulation through carrier depletion at the doped region.

At the coupling point, one or more couplers 230 may be provided in order to couple the light source to the PIC subcircuit 200. For instance, a pair of laser grating couplers may be provided to receive a laser light source. The one or more couplers may be directly connected to a splitter 240 in order to split the incoming optical signal, thereby reducing the power of the optical signal within each splitter branch. The amount of reduction may depend on the number of branches and stages included in the splitter 240. For instance, in the case of a 1×2 or 2×2 splitter having a single stage, the optical power may be halved by the splitter. The 1×2 splitter may be used for an arrangement in which the coupling point 210 includes a single coupler and the 2×2 splitter for an arrangement in which the coupling point 210 includes a pair of input couplers. Using a pair of input couplers allows for redundancy in the incoming optical signal, which may be advantageous for applications requiring high reliability. In either such arrangement, the splitter 240 may be a multimode interference (MMI) splitter. By splitting the optical power at or close to the coupling point 210, which is the location at which the optical power is highest, the onset of nonlinear effects due to high-power optical is avoided or at least delayed. Overall, this has the effect of decreasing attenuation further along the optical path.

In FIG. 2, the splitter 240 is coupled to the modulator 220 through a waveguide 250 having a pair of waveguide arms 250a, 250b. The waveguide arms 250a, 250b of FIG. 2 are designed to have an equal length so that the modulator 220 remains balanced. Additionally, the waveguide 250 may be a rib waveguide, which may be further advantageous for delaying the onset of nonlinearity for an optical signal and reducing the resulting attenuation. The rib waveguide provides less overlap between optical mode and edges, as compared to other waveguides such as strip waveguides. This in turn can lower optical confinement of the received optical signal. It has been observed that nonlinear effects such as absorption and local heating are the result of high optical power density. Therefore, reducing the confinement of the optical signal has the advantage of lowering the optical power density, avoiding the aforesaid nonlinear effects, and preventing losses due to attenuation.

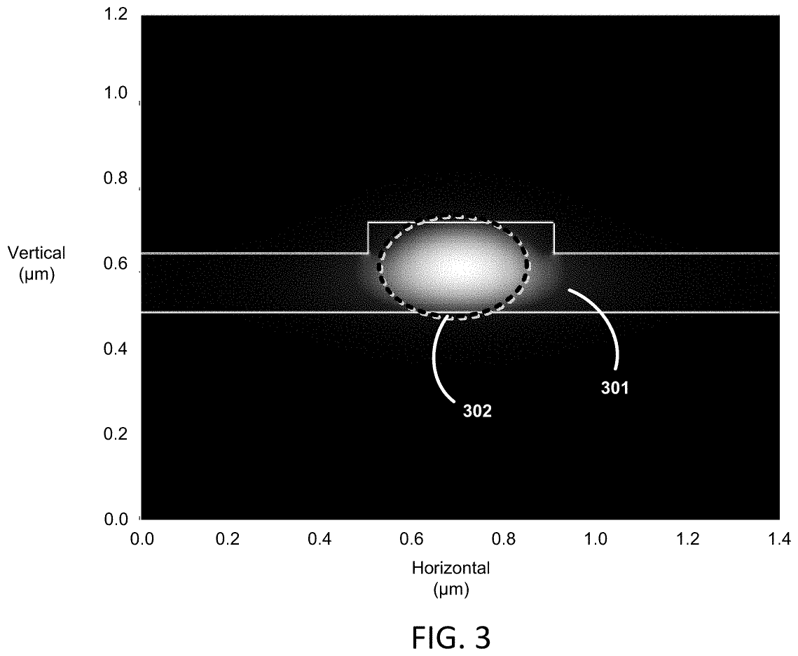

FIG. 3 is a diagram showing an optical mode profile of an optical signal in the rib waveguide of FIG. 2. As shown in FIG. 3, the optical mode profile 301 shows relatively reduced confinement as compared to the profile 302 for a single mode waveguide such as a strip waveguide. In particular, the width of the signal in the horizontal direction is changed from about 0.3 μm to about 0.7 μm, showing a significant reduction in confinement by over 100%.

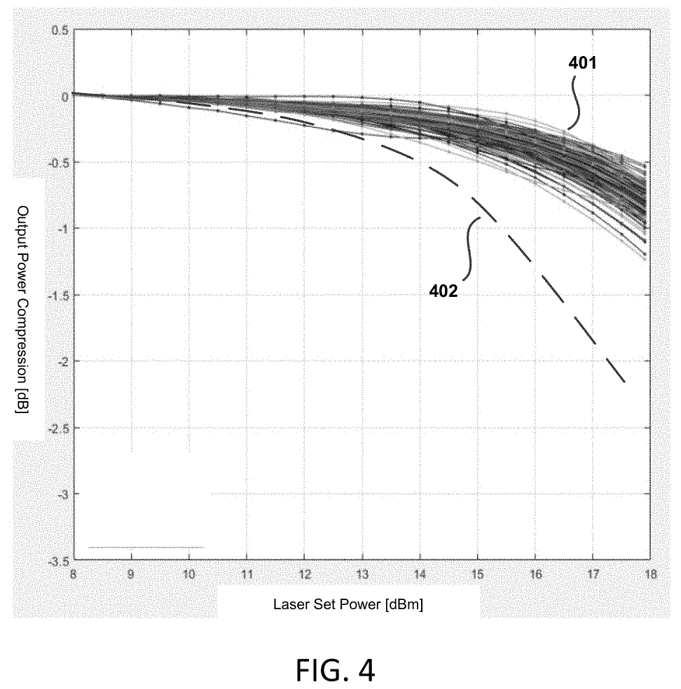

FIG. 4 is a diagram plotting output power as a function of input power of the light beam or laser received by the PIC subcircuit of FIG. 2. A number of plot lines 401 are shown for optical signals having wavelengths between about 1310 nm and 1320 nm. As shown in FIG. 4, for an input signal at 17 dBm, losses in output power are typically between 0.4 dB and 0.8 dB, and the average loss is about 0.6 dB (about 13% loss). For the sake of comparison, typical losses for a PIC subcircuit that does not include a splitter at the coupling point or rib waveguide are represented by line 402, for which the resulting loss from an input power of 17 dBm is nearly 2 dB (about 37% loss). Even better coupling improvement is shown for an input signal at 17.5 dBm, for which the optical losses are reduced from −3.2 dB (about 52% loss) to −1 dB (about 20% loss). This demonstrates that the arrangement of FIG. 2 is capable of reducing losses at high input optical power by over 30% of the input.

In FIG. 4, reduced attenuation is shown for input optical power levels other than 17 dBm, such as input optical power levels at or above 14 dBm. Also, although the diagram ends at 18 dBm, it can be seen from the diagram that similar results can be achieved for higher optical power levels.

The example arrangement of FIG. 2 includes both a splitter at the coupling point of the PIC subcircuit and a rib waveguide. The combination of these two features yields the confinement features shown in FIG. 3 and the output power shown in FIG. 4. However, in other arrangements, only one of these two features may be provided, and the one feature provided may be sufficient to mitigate nonlinear effects and sufficiently reduce signal attenuation. As such, it should be understood that various components of the example arrangement of FIG. 2 may be changed or replaced, and that the resulting arrangement may still provide all or some of the advantages described herein.

Some example changes to the arrangement of FIG. 2 include but are not limited to: replacing the MMI splitter at the coupling point with any other optical splitter, such as a directional coupler or a Y-junction; providing a splitter that splits power by a split ratio other than 1:1; replacing the silicon (Si) waveguides, splitter, grating coupler, or any combination thereof, leading up to the doped portion of the modulator with silicon nitride (SiN) waveguides splitter, grating coupler, or any combination thereof; and providing wide strip waveguides in place of the rib waveguides in order to reduce nonlinear absorption in the path leading up to the doped portion of the modulator.

The above-described PIC arrangements are capable of providing improved performance for silicon photonics technologies using standardized SOI platforms and further without having to provide larger waveguides. This is advantageous because increasing the size of a waveguide can have the unwanted effect of degrading the optical signal through the presence of higher order modes, and introducing RC characteristics that create bandwidth limits and in turn complicate the integration of high-speed elements.

Additionally, because the above-described PIC arrangements are suitable for silicon photonics technologies, good optical signal performance can be achieved even at high optical power levels using readily available and well-developed Si technologies, and without having to rely on platforms made from more costly and lower yield materials such as III/V compound materials (GaAs or InP for example).

The example PIC arrangements of the present disclosure have been described in connection with a PIC integrated in a CWDM. However, those skilled in the relevant art will recognize that the same underlying concepts can be applied to PICs integrated with other devices. For the sake of example, the PIC may be integrated with a parallel single mode (PSM) transceiver to transmit a higher bandwidth of a single wavelength optical signal along parallel fibers or waveguides. In one such application, the PIC may be integrated to feed a PSM optical signal from a splitter or splitter tree to a modulator, such as an MZM modulator.

It should also be understood the concepts described herein are applicable to both transverse electric (TE) and transverse magnetic (TM) mode waves, since optical power density for either type of wave may be controlled using the principles described herein.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order, such as reversed, or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A photonic integrated circuit (PIC) including at least one PIC subcircuit comprising:
one or more couplers configured to receive light from a light source;
a splitter directly coupled to the one or more couplers;
a modulator; and
a connecting waveguide configured to connect the splitter to the modulator.

2. The PIC of claim 1, wherein the one or more couplers is a pair of couplers, and wherein the splitter is a 2×2 splitter.

3. The PIC of claim 2, wherein the pair of couplers is a pair of grating couplers.

4. The PIC of claim 2, wherein the splitter is a 2×2 multimode interference (MMI) splitter.

5. The PIC of claim 1, wherein the connecting waveguide includes a plurality of waveguide arms, each arm coupled to a respective output of the splitter, wherein the waveguide arms have equal length.

6. The PIC of claim 5, wherein the plurality of waveguide arms is a pair of rib waveguides.

7. The PIC of claim 5, wherein the plurality of waveguide arms is a pair of strip waveguides.

8. The PIC of claim 1, wherein the connecting waveguide has a width of about 400-600 nm and a height of about 200-220 nm.

9. The PIC of claim 1, wherein the connecting waveguide is formed from either silicon or silicon nitride.

10. The PIC of claim 1, wherein the modulator is a Mach-Zehnder modulator (MZM) configured to operate in a carrier-depletion mode.

11. The PIC of claim 10, wherein the at least one PIC subcircuit is configured to transmit optical signals using an advanced modulation format.

12. The PIC of claim 1, wherein, for an optical signal having a wavelength between 1310-1320 nm and received at a power level between 16-18 dBm, an attenuation of the optical signal at the at least one PIC subcircuit is between about −0.25 dB and about −1.25 dB.

13. A photonic integrated circuit (PIC) including at least one PIC subcircuit comprising:
one or more couplers configured to receive an optical signal having an optical power intensity at or above 16 dBm;
a rib waveguide configured to receive the optical signal from the one or more couplers and to lower the optical power intensity of the optical signal to below 16 dBm; and
a modulator configured to receive the optical signal from the rib waveguide at the optical power intensity below 16 dBm and to modulate the received optical signal.

14. The PIC of claim 13, wherein the rib waveguide is formed from either silicon or silicon nitride, and wherein the modulator includes a doped portion formed from silicon.

15. The PIC of claim 14, wherein the modulator is a Mach-Zehnder modulator (MZM) configured to operate in a carrier-depletion mode.

16. The PIC of claim 13, wherein the rib waveguide is configured to have a lower optical confinement than a strip waveguide of comparable width.

17. The PIC of claim 1, wherein the PIC includes a plurality of PIC subcircuits, comprising:
a respective connecting waveguide;
a respective splitter coupled to the respective connecting waveguide of the same PIC subcircuit; and
a respective modulator coupled to the respective splitter of the same PIC subcircuit, and
wherein the apparatus further comprises a coarse-wavelength division multiplexer (CWDM) coupled to the respective modulators of the plurality of PIC subcircuits.

18. The PIC of claim 17, further comprising an edge coupler configured to interface the CWDM with an optical fiber.

19. An apparatus comprising a parallel single mode (PSM) transceiver including the PIC of claim 1.

20. A system comprising:
the PIC of claim 1; and
the light source, wherein the light source is a high-power continuous wave (CW) laser.
